(19) United States
(12) Patent Application Publication
(10) Pub. No.: US 2011/0161953 A1
(43) Pub. Date: Jun. 30, 2011

(54) METHOD FOR OPERATING A HOSPITAL INFORMATION SYSTEM

(76) Inventors: Lutz DOMINICK, Eggolsheim (DE); Karlheinz Dorn, Kalchreuth (DE); Stefan Karg, Röthenbach (DE); Andreas Siwick, Erlangen (DE)

(21) Appl. No.: 12/649,495

(22) Filed: Dec. 30, 2009

(51) Int. Cl. G06F 9/445

(52) U.S. Cl. 717/176

(57) ABSTRACT

A method for operating a hospital information system, including a plurality of computer machines interconnected in a network, is provided that keeps data and configurations globally consistent during installation, upgrade or update of the system or its subsystems, and ensures the ability of the distributed subsystems to cooperate on a single machine as well as between several machines without the need to execute the software manipulations on all machines at the same time. To this end, at least one embodiment of the method includes providing a installing module on one of the computer machines; extracting the software data from the installing module and writing the software data to a hard disk of the one computer machine; providing a set of software manipulation operations; choosing a number of software manipulation operations from the set based on the software data extracted from the installing module and executing the number of software manipulation operations on the one computer machine.

### FIELD

At least one embodiment of the present invention generally relates to hospital information systems, and in particular at least one embodiment relates to a method for operating a hospital information system comprising a plurality of computer machines interconnected in a network.

### BACKGROUND

A hospital information system is a comprehensive, integrated information system designed to manage the administrative, financial and clinical aspects of a hospital or other medical installations. These hospital information systems are usually based on a network of server and client machines and help to organize the medical treatment comprising diagnostic tasks such as radiology or other examinations as well as treatment tasks. Due to the complexity of such a hospital information system, these systems usually comprise a number of subsystems distributed on a number of computer machines interconnected in a network which provide the required features and their components.

Regarding the data structure, a hospital information system mirrors this complex structure by having several architectural layers such as presentation logic, business logic and remote services. The distribution and installation of the software therefore concerns the system, its subsystems and features and mostly comprises several architectural layers regarding the respective programs, configurations and data.

For the manipulation of software data present on the systems and subsystems of the hospital information system usually an installer program or installing module is provided for performing installation tasks. These installing modules e.g. comprise mechanisms such as a primary installation package (e.g. a Microsoft MSI-file) and a secondary installation package (e.g. a Microsoft CAB-file) as well as the possibility of several custom actions per file. If the installation operation is a simple update, installed software files may be replaced by newer files through execution of the installing module.

However, the properties of known installing modules lead to a rather holistic and monolithic work procedure and do not provide additional technical or semantic functional layers and services that e.g. provide new types of installation operations that allow an arbitrary finer or coarser scaling mode of operation in large distributed systems or that account for the architectural properties and the technical handling of the current installation status orthogonal to the respective files.

### SUMMARY

Due to the above shortcomings of the prior art, hospital information systems therefore lack flexibility regarding the manipulation of software in their several systems and subsystems.

Accordingly, at least one embodiment of the present invention provides a method of operating a hospital information system that keeps data and configurations globally consistent during installation, upgrade or update of the system or its subsystems, and ensures the ability of the distributed subsystems to cooperate on a single machine as well as between several machines without the need to execute the software manipulations on all machines at the same time.

At least one embodiment of the present invention provides a method of operating a hospital information system that meets the requirements of a delicate on-demand mode of operation within a heterogeneous machine environment.

At least one embodiment of the present invention provides an improved method for operating a hospital information system that allows software manufacturers, service technicians, administrators and users to finish a software manipulation operation, be it an installation, an update, an upgrade or a D installation automatically and within the shortest possible time.

To the accomplishment of the foregoing and related ends, at least one embodiment of the invention then comprises the features hereinafter fully described and particularly pointed out in the claims, the following description and drawings setting forth in detail certain illustrative embodiments of the invention, these being indicative, however, of but several of the various ways in which the principles of the invention may be employed.

### BRIEF DESCRIPTION OF THE DRAWINGS

The above brief description as well as further objects, features and advantages of the present invention will be more fully appreciated by referring to the following description of an example but nonetheless illustrative embodiment in accordance with the present invention when taken in connection with two figures of the accompanying drawing, wherein

FIG. 1 is a schematic diagram illustrating the method according to an embodiment of the invention, and

FIG. 2 is a schematic diagram illustrating several machines of a hospital information system interconnected in a network.

### DETAILED DESCRIPTION OF THE EXAMPLE EMBODIMENT

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

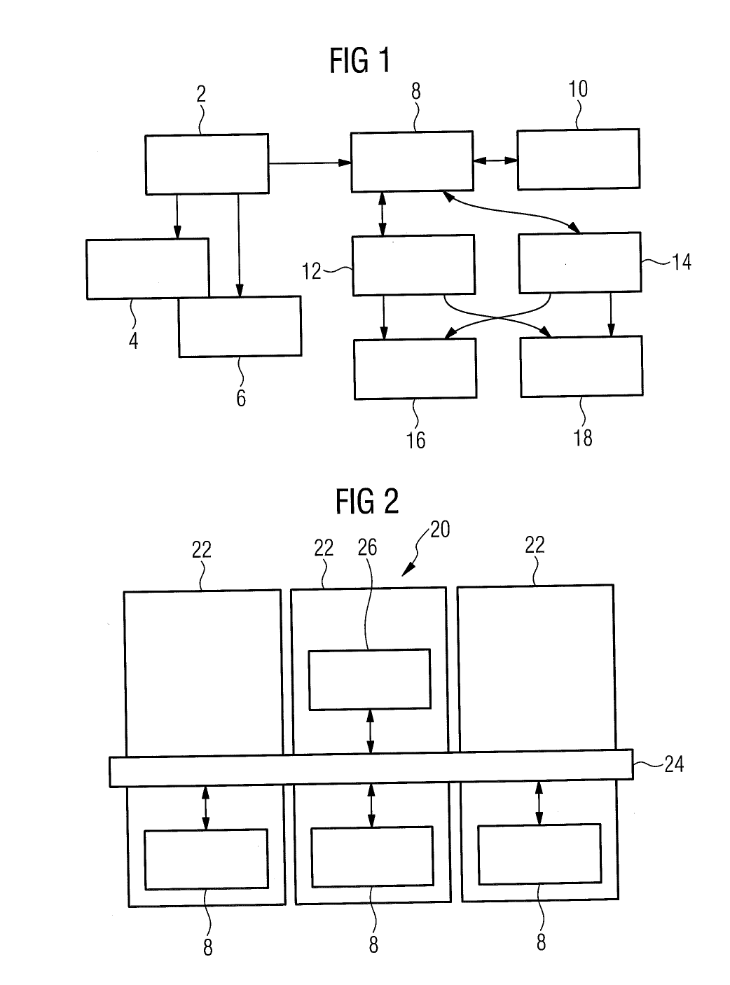

Referring to the drawing, FIG. 1 schematically shows the steps of the method for operating a hospital information system according to the invention. First, an installing module 2 is provided which may e.g. be a Microsoft MSI-file with an embedded or additional Microsoft CAB-file. This installing module 2 contains software data to be installed on the hospital information system.

The data contained in the installing module 2 may be usable for all machines or any particular machine of the hospital information system. The data comprises one or multiple packaged assets, which contain one or multiple entities of code, configurations, and data files 4, 6.

Now, to achieve a particularly flexible and adaptable mode of installation, the installing module is not simply executed in order to write its data, for example, right into the code on a hard disc of a machine of the hospital information system, but rather the programs, configurations or data included in the installing module are extracted and written in a designated directory to the hard disc of a computer machine for later use. Then, a software manipulation module 8 is invoked either automatically or by the installing module 2.

The software manipulation module provides a predefined set of software manipulation operations such as writing data into specific parts of programs present on the machine of the hospital information system. On the basis of the software data 4, 6 contained in the installing module 2, the software manipulation module 8 chooses a number of these software manipulation operations from the provided predefined set and executes these software manipulation operations on the computer machine. Thus, the one or multiple entities of code, configurations, and data files 4, 6 are each being processed by the software manipulation module 8 accordingly.

Furthermore, a history module 10 comprising information on past executed software manipulation operations is provided. The history module 10 contains information on which software manipulation operations were already executed, and which software manipulation operations must or must not (yet) be executed. The software manipulation module 8 then chooses the software manipulation operations to be executed additionally based on the information comprised in said history module 10 and stores information on the chosen and executed number of software manipulation operations into the history module 10 for later use.

Compared to the holistic and monolithic mode of operation that is the simple execution of the installing module 2, the software manipulation module 8 together with the pre-information contained in the history module 10 can automatically and configurably detect the actual situative context and choose the appropriate operation (e.g. install, de-install, update, upgrade) which allows an independent handling of program code, configuration and data files 4, 6. Every software manipulation operation is adapted to the actual installation status on the respective machine by accordingly parametrizing the respective software manipulation operations with their flexible and configurable actions for each defined phase.

Due to the flexibility in the definition of the software manipulation operations, the software manipulation module may flexibly allow or prohibit a certain software manipulation operation and can also optimize the order of execution of the chosen number of software manipulation operations.

Therefore, the architectural layers of the hospital information system are handled in the correct and configurable order, based on the structure of the installation package and e.g. for the respective systems, subsystems or specific features.

These flexibly configurable software manipulation operations usually run once and are customized to the specific installing module 2. For a particularly simple and reliable installation of data on the hospital information system, the predefined set of software manipulation operations provided by the software manipulation module 8 comprises a number of mandatory software manipulation operations 12 that are always chosen and executed compared to the customized software manipulation operations 14 that are only executed once. An example for such a mandatory software manipulation operation would be a generic import function for new configurations into a configuration repository. An example for once executed, adapted software manipulation operations would be the copying of changeable XML template files into target directories or migrations of user specific configurations or business data due to breaking changes.

Preferably, the mandatory software manipulation operations that are executed for each installing module 2 are executed before the remaining chosen software manipulation operations that are usually customized to the specific installing module 2. Furthermore, a certain software manipulation operation may be executed repeatedly to fulfil its purpose for each provided package within the installing module 2.

In the example embodiment, the software manipulation operations provided by the software manipulation module 8 are naturally independent. Therefore, each software manipulation operation may make decisions by means of control structures local to the respective software manipulation operation that only concern the package related to the respective software manipulation operation and its scope. The decisions are made on the basis of the information of the history module 10 (e.g. executed prior software manipulation operations) and the structure of the data 4, 6 in the installing module 2. The independence of each software manipulation operation with respect to each other predefined software manipulation operation guarantees that programs 16 on one hand and configurations and other data 18 on the other hand can be handled both separately or in common and already present configurations and data can be reused and/or selectively transferred to an older or newer state. The program code may then be kept at a certain installation status, and these statuses may be separately removed or changed to their prior state.

An embodiment of the invention allows a software manipulation operation, its scope and its related programs, configurations and data to be processed locally, flexibly, and in conformity with architectural and performance requirements. In the preferred embodiment, each software manipulation operation runs configurably always or once and executes configurable tasks such as an install, upgrade, update or de-install. The software manipulation operations are chosen based on the data 4, 6 in the packaged assets of the installing module 2 and the history module 10 without dependency of one software manipulation operation on another or the features provided in the installing module 2. The independence of each software manipulation operation also allows free choice of the times when a certain software manipulation operation is executed, i.e., either prior to or after a certain manipulation operation or at the start of a system or subsystem after a certain software manipulation operation.

FIG. 2 shows a schematic diagram of a hospital information system 20 comprising several computer machines 22 interconnected via a network 24. Here, a software manipulation module 8 is provided on each computer machine 22 to administrate all software installing operations on the respective computer machine 22 and the data required by the software manipulation module 8, such as the installing modules 2, is supplied by a central data repository 26 and distributed to the respective software manipulation module 8 by the network 24. To this end, the network 24 comprises a unidirectional service and event bus.

The method for operating a hospital information system 20 described in the preferred embodiment and depicted in the drawings allows an automatic distributed and parallel installation, update, upgrade and the installation. This may be achieved by either a single or several software manipulation modules 8 distributed throughout the hospital information system 20. Through the separation and localization of the software manipulation into a customizable and configurable software manipulation module 8, a manipulation of the software can be done independently of e.g. a standard installing module provided by a software manufacturer and may additionally be handled with a particularly high flexibility (e.g. how much replacement, add-on, side-by-side or migration is required). The actual context of the installation, update, upgrade or deinstallation is completely and automatically detectable within the hospital information system 20, and therefore the method scales with the architecture of the system. Distributed installations remain operable and cooperative even during updates. Manual corrections during installation and specifically during updates and upgrades are no longer necessary.

A latitude of modification, change and substitution is intended in the foregoing disclosure and in some instances some features of the invention will be employed without a corresponding use of other features. Accordingly, it is appropriate that the appended claims be construed broadly and in a manner consistent with the spirit and scope of the invention herein.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

### REFERENCE NUMERALS

2 installing module
4,6 code, configuration and data files
8 software manipulation module
10 history module
12 mandatory software manipulation operation
14 software manipulation operation
16 programs
18 configurations and other data
20 hospital information system
22 computer machine
24 network
26 data repository

What is claimed is:

1. A method for a hospital information system including a plurality of computer machines interconnected in a network, the method comprising:
providing an installing module on one of the plurality of the computer machines;
extracting software data from the provided installing module and writing the software data to a hard disk of the one of the plurality of the computer machines;
providing a set of software manipulation operations;
choosing a number of software manipulation operations from the provided set based on the software data extracted from the installing module; and
executing the chosen number of software manipulation operations on the one of the plurality of the computer machines.

2. The method of claim 1, further comprising:
providing a history module including information on previously executed software manipulation operations,
wherein said choosing of a number of software manipulation operations from the provided set is additionally based on said information included in the history module,
and wherein information on said chosen and executed number of software manipulation operations is stored into said history module.

3. The method of claim 1, further comprising
choosing an order of execution of said chosen number of software manipulation operations based on the software data extracted from the installing module.

4. The method of claim 1, wherein said set comprises a number of mandatory software manipulation operations that are always chosen and executed.

5. The method of claim 4, wherein said number of mandatory software manipulation operations are executed before remaining chosen software manipulation operations.

6. The method of claim 1, wherein a number of said software manipulation operations are executed repeatedly.

7. The method of claim 1, wherein said number of software manipulation operations are mutually independent.

8. The method of claim 1, wherein said installing module is provided from a central installing module repository and transmitted to said one of the plurality of the computer machines via said network.

9. A hospital information system, comprising:
a plurality of computer machines interconnected in a network, at least one of said plurality of computer machines comprising a hard disk; and
a software manipulation module to, when executed, perform the method according to claim 1.

10. The method of claim 2, further comprising
choosing an order of execution of said chosen number of software manipulation operations based on at least one of the software data extracted from the installing module and said information included in said history module.

11. A method for a hospital information system including a plurality of computer machines interconnected in a network, the method comprising:
extracting software data from an installing module and writing the software data to a hard disk of at least one of the plurality of the computer machines;
providing a set of software manipulation operations;
choosing a number of software manipulation operations from the provided set based on the software data extracted from the installing module; and
executing the chosen number of software manipulation operations on the at least one of the plurality of the computer machines.

12. The method of claim 11, further comprising:
providing a history module including information on previously executed software manipulation operations,
wherein said choosing of a number of software manipulation operations from the provided set is additionally based on said information included in the history module,
and wherein information on said chosen and executed number of software manipulation operations is stored into said history module.

13. The method of claim 11, further comprising
choosing an order of execution of said chosen number of software manipulation operations based on the software data extracted from the installing module.

14. The method of claim 12, further comprising
choosing an order of execution of said chosen number of software manipulation operations based on at least one of the software data extracted from the installing module and said information included in said history module.

15. A hospital information system, comprising:
a plurality of computer machines interconnected in a network, at least one of said plurality of computer machines comprising a hard disk; and
a software manipulation module to, when executed, perform the method according to claim 11.

16. A computer readable medium including program segments for, when executed on a computer device, causing the computer device to implement the method of claim 1.

17. A computer readable medium including program segments for, when executed on a computer device, causing the computer device to implement the method of claim 11.
